(19) United States
(12) Patent Application Publication
(10) Pub. No.: US 2022/0197936 A1
(43) Pub. Date: Jun. 23, 2022

(54) METHOD AND SYSTEM FOR PROVIDING CONTENT TO RECIPIENT

(71) Applicants: Brian Michael Millar, East Molesey (GB); Torie Chilcott, East Molesey (GB)

(72) Inventors: Brian Michael Millar, East Molesey (GB); Torie Chilcott, East Molesey (GB)

(21) Appl. No.: 17/131,623

(22) Filed: Dec. 22, 2020

(51) Int. Cl. G06F 16/435; G06F 16/483; G06F 16/45

(52) U.S. Cl. CPC G06F 16/437; G06F 16/45; G06F 16/483

(57) ABSTRACT

Disclosed is a method for providing content to a recipient. The method comprises determining a preferred metacategory of the recipient; selecting content having a same metacategory; and providing the selected content to the recipient, wherein metacategory is not category of subject matter of content, but category of mood of content. Disclosed also is a system for providing content to a recipient. The system comprises a data processing arrangement configured to determine a preferred metacategory of the recipient; select content having a same metacategory; and provide the selected content to the recipient, wherein metacategory is not category of subject matter of content, but category of mood of content. Further, disclosed also is a computer program product comprising a non-transitory computer-readable storage medium having computer-readable instructions stored thereon, the computer-readable instructions being executable by a computerized device comprising processing hardware to execute the aforementioned method.

### TECHNICAL FIELD

The present disclosure relates generally to data communication and distribution; and more specifically, to methods and systems for providing contents to recipients, based on the preferred perception of contents by the recipients.

### BACKGROUND

Marketing communication has been adopted as a fundamental part of a company's marketing efforts. Marketing communication includes advertising, direct marketing, branding, packaging, online presence, printed materials, PR activities, sales presentations, sponsorships, trade show appearances and so on. Typically, companies generate and circulate content, such as message and media, describing the marketable product or service and use or effects thereof. Marketing communication plans ensure said content reaches a wider section of people thereby encouraging preference for the product or service and creating and sustaining demand therefor. However, companies plan marketing communications without any understanding of the likelihood of a given audience engaging with the generated content.

Conventional marketing communication have targeted audience using social platforms, such as Google, Facebook, YouTube, online selling websites, and the like. Conventional solutions, such as individual intuition, Google Affinity data, Facebook Affinity data, and the like, provide a generalized content specific for a subject matter, such as sports, travel, banking, make-up, entertainment, and so forth. However, such conventional solutions merely focus on the subject matter of the content but fail to take into account that customers may be interested in content similar to the current content and will thus fail to identify large groups of potential customers. Moreover, such conventional solutions are expensive and require companies to pay generously for their services without receiving much value for the efforts.

Therefore, considering the foregoing discussion, there exists a need to overcome the aforementioned drawbacks associated with conventional content generation for generating content that reaches a wider audience.

### SUMMARY

In addition to the problems as indicated above, the inventors have realized that the conventional marketing communications fail to investigate what it is about a content that engages an audience and the inventors have realized that categorizing this as metadata for content, one is able to reach a wider audience that will be equally engaged by the present content based on the engagement of other content having a similar such metacategory.

In this aspect, the inventors have further realized that conventional marketing communications fail to accurately estimate the tone of the content and the potential likeness therefor by the audience, i.e. how the audience will perceive the content. Furthermore, the conventional ways fail to provide a predictive model that enables companies (brands and agencies alike) to create content of optimum tone to appeal to the target audience based on a predicted manner in which the audience perceives the content, how the content engages the audience.

As the inventors have further realised after inventive and insightful reasoning, there is thus a problem, as is discussed briefly above, in that conventional marketing communications are inaccurate in measuring the tone of the content and are unlikely to account for the level of influence or engagement of the content on the audience, i.e. the predicted manner of engaging the audience such as in which manner the audience perceives the content. Perception herein relating to a way of regarding, understanding, or interpreting something; a mental impression as defined in the online dictionary Oxford Languages.

One object of the teachings herein is to overcome or at least mitigate the problems of the prior art.

To achieve such an object, the inventors have realized that by categorizing and utilizing an unquantifiable trait, such as a tone or mood, by categorizing how it is perceived by an audience, it is possible to select relevant content to be delivered such that the content not only relates to the same subject matter, for example cars, movies, makeup, sports equipment and other articles or activities, but also to articles or activities sharing a commonality in said unquantifiable trait.

Also, the inventors have furthermore realized that categorization of the unquantifiable trait enables selection of an increased number of relevant content and increased accuracy of the delivered content being accepted by a recipient or user.

According to one aspect, the object is achieved by providing a method for providing content to a recipient, the method comprising:
determining a preferred metacategory of the recipient;
selecting content having a same metacategory; and
providing the selected content to the recipient, wherein the metacategory is not a category of a subject matter of the content, but a category of a mood of the content.

Embodiments of the present disclosure enable the determination of a preferred manner of perceiving content, i.e. the mood of content by a recipient and selecting content having a same mood, i.e. metacategory, to match the preferred mood (preferred manner of perceiving content) of the recipient and delivering the selected content to the recipient.

In one embodiment, the metacategory relates to an engagement category, wherein the engagement category indicates a predicted manner in which the content will be perceived.

In one embodiment, the metacategory of the recipient corresponds to a ranking of selected perceptions of presentations representing various content.

In one embodiment, the method further comprises determining the preferred metacategory of the recipient by:
presenting content, the content being associated with at least one metacategory;
receiving a selection of the content; and
determining the preferred metacategory as the metacategory of the selected content.

In one embodiment, the method comprises:
presenting content includes presenting a plurality of images, each image representing a metacategory;
receiving a selection of the content includes receiving a selection of a subset of the presented plurality of images, each selection of an image being a selection of a metacategory; and
determining the preferred metacategory as the metacategory of the selected content includes selecting the most selected metacategory as the preferred metacategory.

In one embodiment, the method comprises:
presenting the plurality of images includes presenting a set of images at a time, and
receiving the selection of a plurality of images includes receiving a series of selections of images, one from each set.

In one embodiment, determining a preferred metacategory of the recipient includes determining a preferred metacategory of a group that the recipient belongs to.

In one embodiment, the preferred metacategory is selected from at least one of the categories of content: a humorous content, an aesthetic content, an inspiring content, and a useful content.

In one embodiment, determining a preferred metacategory of the recipient includes determining one or more sub-categories of the one or more metacategory.

In one embodiment, the one or more sub-categories of the categories of contents is selected from at least one of: consumer reviews, handy hints, trivia, hotlists, authoritative opinion, search or answer, news analysis, news updates, social good, cute, ethereal, minimalist, extravagant, stylized or abstract, spontaneous, pop, sensual, wonder, heartwarming, spiritual, big ideas, enraging, thrilling, life coaching, parody, surreal, dark, outrageous, satire, slapstick, deadpan, and self-deprecating.

In one embodiment, the one or more sub-categories of the useful content is selected from at least one of: consumer reviews, handy hints, trivia, hotlists, authoritative opinion, search or answer, news analysis, news updates, and social good.

In one embodiment, the one or more sub-categories of the aesthetic content is selected from at least one of: cute, ethereal, minimalist, extravagant, stylized or abstract, spontaneous, pop, and sensual.

In one embodiment, the one or more sub-categories of the inspiring content is selected from at least one of: wonder, heartwarming, spiritual, big ideas, enraging, thrilling, and life coaching.

In one embodiment, the one or more sub-categories of the humorous content is selected from at least one of: parody, surreal, dark, outrageous, satire, slapstick, deadpan, and self-deprecating.

In one embodiment, the preferred metacategory is determined based on research data.

In one embodiment, the research data is obtained from at least one of: a market research, a psychological research, an online panel research, an in-person interview, a telephonic interview, a cross-sectional study, a customer survey template, a community survey template, and an industrial survey template.

According to one aspect, the object is achieved by providing a system for providing content to a recipient, the system comprising a data processing arrangement configured to:
determine a preferred metacategory of the recipient;
select content having a same metacategory; and
provide the selected content to the recipient, wherein the metacategory is not a category of a subject matter of the content, but a category of a mood of the content.

In one embodiment, the data processing arrangement is further configured to determine the preferred metacategory of the recipient by:
presenting content, the content being associated with at least one metacategory;
receiving a selection of the content; and
determining the preferred metacategory as the metacategory of the selected content.

In one embodiment, the data processing arrangement is further configured to:
present content by presenting a plurality of images, each image representing a metacategory;
receive a selection of the content by receiving a selection of a subset of the presented plurality of images, each selection of an image being a selection of a metacategory; and
determine the preferred metacategory as the metacategory of the selected content includes selecting the most selected metacategory as the preferred metacategory.

In one embodiment, the data processing arrangement is configured to:
present the plurality of images by presenting a set of images at a time, and
receive the selection of a plurality of images includes receiving a series of selections of images, one from each set.

According to one aspect, the object is achieved by providing a computer program product comprising a non-transitory computer-readable storage medium having computer-readable instructions stored thereon, the computer-readable instructions being executable by a computerized device comprising processing hardware to execute aforementioned method.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following drawings wherein:

FIG. 1 is an illustration of steps of a method for providing content to a recipient, according to one embodiment of the teachings herein; and

FIG. 2 is a block diagram of a system for providing content to a recipient, according to one embodiment of the teachings herein.

### DETAILED DESCRIPTION

The following detailed description illustrates embodiments of the present application and ways in which they can be implemented. Although some modes of carrying out the present teachings have been disclosed, those skilled in the art would recognize that other embodiments for carrying out or practising the present teachings are also possible.

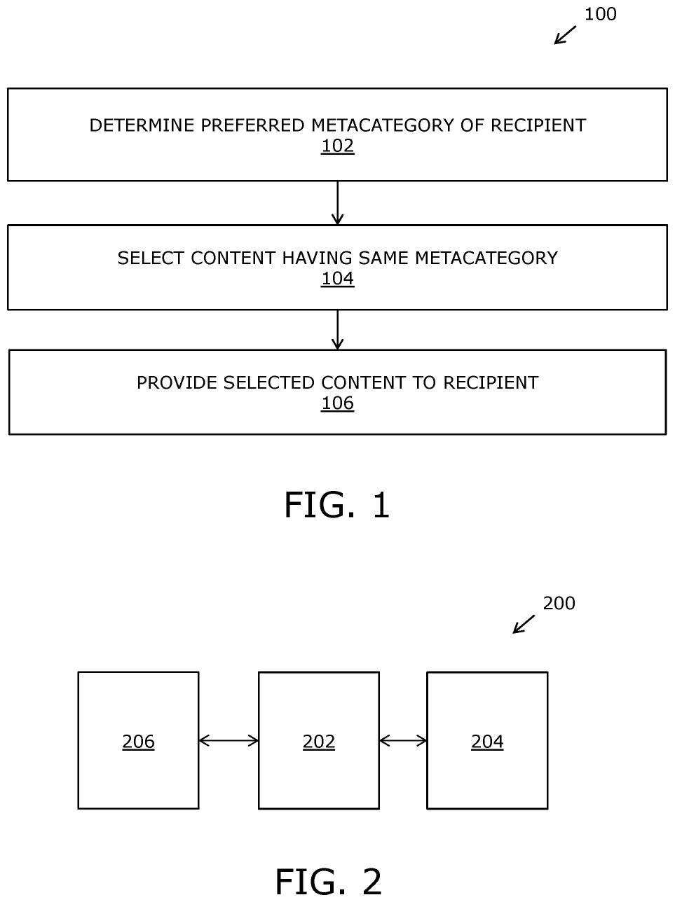

Referring to FIG. 1, illustrated are steps of a method 100 for providing content to a recipient, according to one embodiment of the teachings herein. At step 102, a preferred metacategory of the recipient is determined. At step 104, content having a same metacategory is selected. At step 106, the selected content is provided to the recipient, wherein the metacategory is not a category of a subject matter of the content, but a category of a mood of the content, ie a category of how the content is perceived by a user.

The steps 102, 104 and 106 are only illustrative and other alternatives can also be provided where one or more steps are added, one or more steps are removed, or one or more steps are provided in a different sequence without departing from the scope of the claims herein.

Referring to FIG. 2, shown is a block diagram of a system 200 for providing content to a recipient, according to one embodiment of the teachings herein. The system 200 comprises a data processing arrangement 202. The data processing arrangement 202 is configured to determine a preferred metacategory of the recipient. The data processing arrangement 202 is configured to select content having a same metacategory and provide the selected content to the recipient, wherein the metacategory is not a category of a subject matter of the content, but a category of a mood of the content, ie a category of how the content is perceived by a user.

The method 100 and the system 200 both allow efficient selection and delivery of content to a wider range of recipients based on recipients' preference. Specifically, the method uses a predicted manner in which the content will be perceived by the recipient (indicated by an engagement category). Such information allows for the creation of content, and subsequent delivery of the content to the recipient to encourage effective engagement thereof with the content. Moreover, the method assigns ranks (namely, weight or score or value) to each of the perceived perception of the content by the recipient, based on the preferred perception thereof by the recipient. Typically, a higher rank is associated with a greater preference for a delivered (namely, presented) content. The weights represent the number of times the said content is selected by the recipient when it is presented to the recipient. Therefore, content having higher weights associated therewith contribute more to the recipient engagement therewith. Furthermore, the method broadly categorizes the tone of the content, into a useful, a beautiful, an inspiring or a humorous content, based on a mood of the recipient identified from research data comprising market research, psychological research and other surveys. The method accurately represents a robust framework for predicting the content preference and generating the content, having a same mood to match the preferred mood of the recipient, that would lead to an effective engagement of the recipient with the said mood of the content.

Furthermore, the method of the present disclosure employs a unique 32-genre (namely, perceived perception) framework of content for encouraging content producers to generate content to fit the preference of a recipient. Moreover, the method of the present disclosure provides ranking of the mood of the content. Beneficially, such ranking of the mood of the content is highly correlated with the engagement profiles of a given recipient. In other words, the ranking of perceived perception of the content by a given recipient enables determining a level of preference thereof by the given recipient.

Examples of embodiments according to the teachings herein will now be described in detail with simultaneous reference to FIGS. 1 and 2.

Throughout the present disclosure, the term “data processing arrangement” as used herein relates to programmable and/or non-programmable components configured to execute one or more software application for storing, processing, sharing data and/or set of instructions. Optionally, the data processing arrangement 202 is a set of one or more hardware components or a multi-processor system, depending on a particular implementation. More optionally, the data processing arrangement 202 includes, for example, a component included within an electronic communications network. Additionally, the data processing arrangement 202 includes one or more data processing facilities for storing, processing, sharing data and/or set of instructions. Optionally, the data processing arrangement 202 includes functional components, for example, a processor, a memory, a network adapter and so forth. Optionally, the data processing arrangement 202 is communicably coupled to a data repository (or database) 204. The data repository 204 stores information in a structured or unstructured format. In an embodiment, the data repository 204 comprises information relating to some or all of: a plurality of platforms providing the content, a plurality of contents, recipients information, a log of viewed contents, a date and time duration associated with each viewing thereof, feedback with respect to the viewed content, and so on.

Throughout the present disclosure the term “content” as used herein refers to an information associated with a product or service directed towards a recipient. Typically, the content contains a subject matter. The content is associated with or comprises a metacategory which in turn represents a mood or feeling associated with the content, wherein the mood enables the subject matter to be presented to an audience perhaps not directly interested in the subject matter, but partial to the mood of the subject matter. Moreover, the content requires a medium, such as speech, writing, any form of art, or any combination thereof, for delivery of a message (or information) to a recipient via a suitable media, such as internet, print, television, radio, and so forth. Moreover, content also leads to creation of new content derived from or an improvement of an existing content (re-cycling content). Furthermore, the medium of the content affects the perception of the content by the recipient. In an example, the content can be an advertising content.

The term “recipient” as used herein refers to a receiver of an information, i.e. the content. Typically, the recipient is an audience, such as a viewer, a reader, a listener or a player. The recipient may be an individual or a group of people belonging to a specific age group, gender, community, ethnicity, religion, hobbies, profession, faculty, political inclination, financial power or nationality, for example. Moreover, psychology of the recipient plays an important role in determining the consumer behavior towards the delivered content. Optionally, a positive consumer behavior is determined by the perspective and perception of the recipient of the delivered content. Therefore, the content may be provided based on a personal or cultural preference of the recipient. Beneficially, content based on personal or cultural preference of the recipient enables building a better brand value for the product or service associated with the content, thereby giving an immediate boost to the organization providing said product or service.

At step 102, a preferred metacategory of the recipient is determined. The term “metacategory” as used throughout the present disclosure refers to a classification of people or things regarded as having a particular shared characteristic. Optionally, the metacategory is a special category that includes other one or more sub-categories that are grouped by specific characteristic. More optionally, the metacategory broadly includes actions, activities, events, processes and states. In an embodiment, the metacategory relates to an engagement category, wherein the engagement category indicates a predicted manner in which the content will be perceived. In this regard, the metacategory typically relates to cognitive representations or framework that enable perception of the content by the recipients throughout the world.

The term “preferred metacategory of the recipient” as used throughout the present disclosure refers to the metacategory that draws maximum recipient preference or engagement therewith. In other words, the preferred metacategory of the recipient is the preference for selected perceptions of presentations representing various content. Optionally, the preferred metacategory is governed by a current psychological state (namely, mood) of the recipient. It will be appreciated that the content is perceived differently by different recipients.

In an embodiment, the preferred metacategory is selected from at least one of the categories of content: a humorous content, an aesthetic content, an inspiring content, and a useful content. More optionally, humor may be related to a funny subject, aesthetic that may be related to beauty and styling, inspirational may be related to life-coaching, and useful may be related to an analysis of a situation, for example, a news or share market for the day or week. In an example, if a given recipient is interested in seeking financial planning, a preferred metacategory for the given recipient may be selected from any of the useful or inspirational. Similarly, if a given recipient is interested in styling, a preferred metacategory for the given recipient is the aesthetics.

In an embodiment, determining a preferred metacategory of the recipient includes determining one or more sub-categories of the one or more metacategory. As mentioned above, the metacategory is a special category that includes other one or more sub-categories that are grouped by specific characteristic. In other words, the sub-category is a subdivision of a larger category, i.e. the metacategory, based on special characteristic, such as for example, the tone or mood of the content. In an embodiment, the one or more sub-categories of the one or more metacategory is selected from at least one of: parody, surreal, dark, outrageous, satire, slapstick, deadpan, self-deprecating, cute, ethereal, minimalist, extravagant, stylized or abstract, spontaneous, pop, sensual, wonder, heartwarming, spiritual, big ideas, enraging, thrilling, life coaching, consumer reviews, handy hints, trivia, hotlists, authoritative opinion, search or answer, news analysis, news updates and social good. Beneficially, such unique 32 sub-categories of content provides a dataset of global content preferences of recipients worldwide.

In an embodiment, the one or more sub-categories of the humorous content is selected from at least one of: parody, surreal, dark, outrageous, satire, slapstick, deadpan, and self-deprecating. Notably, said sub-categories are all forms of humor. Typically, humor is highly subjective and perceived differently by different recipients. In an example, dark humor (irreverent humor) intentionally disrespects topics that are usually held sacred, such as religion or death, and thus may not be perceived in good light by a big group of recipients unless the recipient is an intelligent lot that can squeeze out the intended information therefrom. In another example, deadpan humor is a raw and emotionless delivery of information about the product or service is a creative and humorous way. Therefore, different types of humorous content, i.e. parody, surreal, dark, outrageous, satire, slapstick, deadpan, self-deprecating, or any other humor, may attract different types of recipients and incite different perceptions thereby.

In an embodiment, the one or more sub-categories of the aesthetic content is selected from at least one of: cute, ethereal, minimalist, extravagant, stylized or abstract, spontaneous, pop, and sensual. The aesthetic content is associated with beauty or appreciation thereof, and brings with it a sense of pleasure and relaxation to the recipient of the content. Moreover, aesthetics covers both natural and artificial sources of objects and environments. Furthermore, aesthetics covers various art forms such as poetry, novels, music, drama, painting, architecture, sculpture, gastronomy, beauty, couture, and so forth. Moreover, aesthetics includes factors such as color, pattern, scale, shape (namely, form), visual weight, lines, movement, balance and the like, and may be categorized as graceful, elegant, exquisite, glorious or nice. In an example, the stylized or abstract content are recognized as a form of art, such as contemporary or modern, and appeal to a vast majority of recipients interested in said art. In another example, in pop culture, aesthetics refers to the overall style of someone or something, such as a sound, interior design or appearance. In yet another example, extravagant aesthetics are directed at showcasing extraordinary and dreamy objects and environments.

In an embodiment, the one or more sub-categories of the inspiring content is selected from at least one of: wonder, heartwarming, spiritual, big ideas, enraging, thrilling, and life coaching. The inspirational content encourages establishing a personal connect and motivates the recipient to bring a positive change in their lives, such as for example spiritual, health-related, finance-related and/or heartwarming. In an example, media visibility of LGBTQ+ people and activists has strengthened the community's movement for civil rights and promoted their rights in various parts of the world.

In an embodiment, the one or more sub-categories of the useful content is selected from at least one of: consumer reviews, handy hints, trivia, hotlists, authoritative opinion, search or answer, news analysis, news updates, and social good. Optionally, the useful content is associated with a high-quality content that builds trust and brand awareness. The useful content, such as consumer reviews or surveys, provide real-world experiences, case studies and scientific data for the content's credibility and thus preference for the brand associated with the product or service of the content.

Optionally, the data processing arrangement 202 employs machine learning algorithms to determine the metacategory of the recipient. More optionally, the machine learning algorithms employ supervised or unsupervised learning techniques. In one example, the machine learning algorithms are used to determine whether the metacategory is either humorous, aesthetic, inspiring, useful or any combination thereof. Herein, the data processing arrangement 202 employs previously received content of the recipient as a learning dataset for comparison with the to-be-delivered content thereto. In another example, the machine learning algorithms are used to identify the suitable media platform for delivering the content. Notably, the machine learning algorithms compare a log of engagement with the platform previously by a given recipient with their current activity thereon. Based, on the historical patterns, the machine learning algorithms determine the perception of content by the recipient, i.e. the metacategory of the recipient.

In an embodiment, the preferred metacategory is determined based on research data. In other words, the machine learning algorithms use research data to extract information corresponding to preferences for selected perceptions of presentations representing various content. In an embodiment, the research data is obtained from at least one of: a market research, a psychological research, an online panel research, an in-person interview, a telephonic interview, a cross-sectional study, a customer survey template, a community survey template, and an industrial survey template. The research data provides data collected from demographically representative panel of recipients (or respondents), such as, for example, consumption habits of over 7000 recipients. Optionally, the research data provides information regarding personal preferences and a cultural (namely, group) preferences of the recipients. In an embodiment, determining a preferred metacategory of the recipient includes determining a preferred metagategory of a group that the recipient belongs to. Optionally, the group that the recipient belongs to includes, but is not limited to, an age group, a gender, a community, an ethnicity, a religion, a hobby, a profession, a faculty, a political inclination, a financial power or a nationality. In an example, a tractor manufacturing company would allocate its marketing budget for promotion of its product amongst an agricultural community of a country rather than targeting a software technology community of the said country.

Optionally, the data processing arrangement 202 is configured to instruct an online tool to create an intuitive histogram, such as a fan-diagram, of engagement profiles of a given recipient based on the data from the machine learning algorithms. In this regard, the engagement profiles of the given recipient are normalized for the population average. Optionally, the computations may be implemented using various programming languages, such as Python, and verified against a spreadsheet implementation of the survey data or the data from the machine learning algorithms. Moreover, a user interface shows a set of editable queries and displays an animation of the histograms computed from each, both relative to each other and relative to the demography. Furthermore, the queries can be saved, loaded, and analyzed, and reports can be generated automatically. Optionally, the data processing arrangement 202 is configured to provide an ad-serving platform plug-in that modifies the content to fit the preference of a given recipient. Optionally, the data processing arrangement 202 is configured to instruct an inspirational content provider to showcase the best examples of each metacategory in countries worldwide.

In an embodiment, the metacategory of the recipient corresponds to a ranking of selected perceptions of presentations representing various content. The term “rank” or “ranking” as used herein refers to a quantifier representative of an importance of the metacategory of the recipient. The rank is typically a number, represented as a fraction of numbers, a decimal number, a percentage, and so forth. The rank assigned to a metacategory is calculated from a number of parameters, such as a frequency and/or duration of engagement, a desired tone, and so forth, associated with the recipient. In other words, the rank may be assigned to a metacategory based on the preference of the recipient for the said metacategory.

In this regard, an overall score is calculated for each of the metacategory based on the perception by the recipient. Typically, a higher rank of the metacategory is associated with a greater level of preference of a given recipient. In an embodiment, the data processing arrangement 202 assigns ranks to the metacategory of the recipient. The ranks represent either the number of views (namely, hits), duration of viewing, or a total number of selection of the said content from a list of similar or dissimilar content. Therefore, the highest scoring metacategory is selected as the preferred metacategory of the recipient. Optionally, each metacategory may be assigned a rank and then the rank is averaged to select a preferred metacategory. Moreover, the ranking is based on a personal preference of the recipient. The method accurately represents the selection of content based on a preference of the recipient, preferably based on a mood of the recipient. Furthermore, optionally, ranking associated with the metacategory may be used to encourage developing the content based on the highest scoring metacategory.

Optionally, the data processing arrangement 202 assigns ranks to the sub-category of the metacategory of the recipient, similar to the ranking of the metacategory of the recipient. In this regard, the sub-category with a higher rank is associated with a greater level of preference of a given recipient for said sub-category. It will be appreciated that the higher-ranking sub-category corresponds to the higher rank of the metacategory, that the sub-category belongs to, by transitive connection.

In an embodiment, the method further comprises determining the preferred metacategory of the recipient by:
presenting content, the content being associated with at least one metacategory;
receiving a selection of the content; and
determining the preferred metacategory as the metacategory of the selected content.

Optionally, in this regard, the content associated with at least one metacategory, not necessarily the preferred metacategory, is presented to the recipient. More optionally, presenting content includes presenting a plurality of images, each image representing a metacategory. In this regard, a set of images, for example at least 3 images representing at least one metacategory, are presented to the recipient at a time. Optionally, the images are indicative of at least one metacategory and/or a sub-category of the metacategory. Optionally, the images are randomly selected, and each set of images may correspond to similar or dissimilar metacategories or sub-categories. Optionally, the images may include a text, a graph, a product or service picture, a brand logo, and so forth.

Optionally, the presented content is selected by the recipient using a user device 206 associated with the recipient. Typically, the user device 206, is communicably coupled to the data processing arrangement 202, and provides a user interface for selection of the presented content. Moreover, receiving a selection of the content includes receiving a selection of a subset of the presented plurality of images, each selection of an image being a selection of a metacategory. Optionally, receiving the selection of a plurality of images includes receiving a series of selection of images, one from each set. In other words, from each set of images presented a smaller subset of images is selected. For example, out of 9 images presented 3 images are selected, wherein a first image selected belongs to a first set of 3 images presented. Similarly, a second image selected belongs to a second set of 3 images presented and a third image selected belongs to a third set of 3 images presented.

Optionally, the preferred metacategory is determined as the metacategory of the selected content. Optionally, determining the preferred metacategory includes selecting the most selected metacategory as the preferred metacategory. Optionally, most selected metacategory is determined by the number of times each metacategory is selected by a recipient when it was presented to the recipient. In this regard, as the recipient is presented with various images, the preferred metacategory is determined by simply counting or otherwise ranking the number of images selected for each metacategory or sub-category as presented. In an example, a given recipient may be interested in skin-care, and therefore, most likely select images related to aesthetics, such as ethereal, minimalist, pop, and so forth, from each set of presented images.

At step 104, content having a same metacategory is selected. Optionally, the content having the metacategory same as the preferred metacategory of the recipient is selected. The content is selected based on the ranking or the most selected metacategory of the recipient. In this regard, the content having a metacategory similar to the preferred metacategory (or most selected sub-category) is selected. Moreover, the metacategory of the content is not a category of the subject matter of the content, but a category of the mood of the content. The term “subject matter of the content” refers to the actual knowledge regarding the product or service to be imparted. The subject matter may for example be sports, travel, banking, make-up, entertainment, and so forth. The term “mood of the content” refers to the manner in which the information regarding the product or service is imparted or perceived by the user. The manner may broadly be humorous, aesthetic, inspirational or useful. Beneficially, selecting content having the same metacategory, i.e. category of the mood of the content, ensures effective recipient engagement with the content, thereby enhancing the preference for the product or service associated with the said content.

Optionally, the data processing arrangement 202 is configured to use machine learning algorithms to select content having the same metacategory. The machine learning algorithms analyze the metacategory of the recipient based on their engagement profile.

Optionally, the machine learning algorithms use a sentiment analysis module to select content having the same metacategory.

At step 106, the selected content is provided to the recipient. In this regard, the selected content is provided, via a suitable media platform, to the recipient. In an example, the selected content may be provided on a digital platform, as audio content, video content, a digital image, or a combination thereof. In another example, the selected media is provided via a print media to advertise or run a campaign to build an audience for a product or service. In this regard, the print media may include, but not limit to, billboards, magazine, notice, and so forth.

The teachings of the present disclosure may, for example, be implemented to build audience and brand value for brands like universities, print and digital media, fast-moving consumer goods, and the like. In an example, in order to appeal to 18 year old students applying to university, a magazine brand may move away from staid infographics into more pop imagery, based on the unique 32-sub-category framework of the present disclosure, to encourage the students to use its Universities guide. Moreover, a change in the tone of voice of the magazine, from Voice of Authority to Curator of Experiences, may further help the magazine to achieve a growth in building their audience. In another example, a brand's creative roots may be re-invented to attract a new generation by including spontaneous and extravagant imagery as well as slapstick humour.

Optionally, the data processing arrangement 202 is further configured to determine the preferred metacategory of the recipient by:
presenting content, the content being associated with at least one metacategory;
receiving a selection of the content; and
determining the preferred metacategory as the metacategory of the selected content.

Optionally, the data processing arrangement 202 is further configured to:
present content by presenting a plurality of images, each image representing a metacategory;
receive a selection of the content by receiving a selection of a subset of the presented plurality of images, each selection of an image being a selection of a metacategory; and
determine the preferred metacategory as the metacategory of the selected content includes selecting the most selected metacategory as the preferred metacategory.

Optionally, the data processing arrangement 202 is configured to:
present the plurality of images by presenting a set of images at a time, and
receive the selection of a plurality of images by receiving a series of selection of images, one from each set.

Furthermore, an embodiment of the teachings described herein provides a computer-readable medium carrying instructions that when loaded into and executed by a data processing arrangement (such as the data processing arrangement 202) causes the data processing arrangement to execute the aforesaid method 100.

Optionally, the computer-readable medium is a tangible device for storing instructions for use by an instruction execution device. The computer-readable medium can direct a computer, other programmable data processing apparatus, or other devices to function in a particular manner, such that the instructions stored in the computer-readable medium cause a series of steps to implement the function specified in a flowchart and/or a schematic block diagram corresponding to the instructions. The computer-readable medium includes, but is not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1-21. (canceled)

22. A method for providing content to a recipient, the method comprising:
determining a preferred metacategory of the recipient, wherein the preferred metacategory of the recipient is determined by:
presenting content, the content being associated with at least one metacategory, wherein presenting content includes presenting a plurality of images, each image representing a metacategory, and wherein presenting the plurality of images includes presenting a set of images at a time;
receiving a selection of the content, wherein receiving the selection of the content includes receiving a selection of a subset of the presented plurality of images, each selection of an image being a selection of a metacategory, and wherein receiving the selection of the plurality of images includes receiving a series of selection of images, one from each set; and
determining the preferred metacategory as the metacategory of the selected content, wherein determining the preferred metacategory as the metacategory of the selected content includes selecting the most selected metacategory as the preferred metacategory;
selecting content having a same metacategory; and
providing the selected content to the recipient.

23. The method according to claim 22, wherein the metacategory relates to an engagement category, wherein the engagement category indicates a predicted manner in which the content will be perceived.

24. The method according to claim 23, wherein the metacategory of the recipient corresponds to a ranking of selected perceptions of presentations representing various content.

25. (canceled)

26. (canceled)

27. (canceled)

28. The method according to claim 22, wherein determining a preferred metacategory of the recipient includes determining a preferred metacategory of a group that the recipient belongs to.

29. The method according to claim 22, wherein the preferred metacategory is selected from at least one of the categories of content: a humorous content, an aesthetic content, an inspiring content, and a useful content.

30. The method according to claim 22, wherein determining a preferred metacategory of the recipient includes determining one or more sub-categories of the one or more metacategory.

31. The method according to claim 30, wherein the one or more sub-categories of the one or more metacategory is selected from at least one of: consumer reviews, handy hints, trivia, hotlists, authoritative opinion, search or answer, news analysis, news updates, social good, cute, ethereal, minimalist, extravagant, stylized or abstract, spontaneous, pop, sensual, wonder, heartwarming, spiritual, big ideas, enraging, thrilling, life coaching, parody, surreal, dark, outrageous, satire, slapstick, deadpan, and self-deprecating.

32. The method according to any one of the claim 31, wherein the one or more sub-categories of the useful content is selected from at least one of: consumer reviews, handy hints, trivia, hotlists, authoritative opinion, search or answer, news analysis, news updates, and social good.

33. The method according to any one of the claim 31, wherein the one or more sub-categories of the aesthetic content is selected from at least one of: cute, ethereal, minimalist, extravagant, stylized or abstract, spontaneous, pop, and sensual.

34. The method according to any one of the claim 31, wherein the one or more sub-categories of the inspiring content is selected from at least one of: wonder, heartwarming, spiritual, big ideas, enraging, thrilling, and life coaching.

35. The method according to any one of the claim 31, wherein the one or more sub-categories of the humorous content is selected from at least one of: parody, surreal, dark, outrageous, satire, slapstick, deadpan, and self-deprecating.

36. The method according to claim 22, wherein the preferred metacategory is determined based on research data.

37. The method of claim 36, wherein the research data is obtained from at least one of: a market research, a psychological research, an online panel research, an in-person interview, a telephonic interview, a cross-sectional study, a customer survey template, a community survey template, and an industrial survey template.

38. A system for providing content to a recipient, the system comprising a data processing arrangement configured to:
determine a preferred metacategory of the recipient, wherein the data processing arrangement is further configured to determine the preferred metacategory of the recipient by:
presenting content, the content being associated with at least one metacategory, wherein content is presented by presenting a plurality of images, each image representing a metacategory, and wherein the plurality of images being presented by presenting a set of images at a time;
receiving a selection of the content, wherein the selection of the content being received by receiving a selection of a subset of the presented plurality of images, each selection of an image being a selection of a metacategory, and wherein receiving the selection of the plurality of images includes receiving a series of selection of images, one from each set;
determining the preferred metacategory as the metacategory of the selected content, wherein the preferred metacategory being determined as the metacategory of the selected content includes selecting the most selected metacategory as the preferred metacategory;
select content having a same metacategory; and
provide the selected content to the recipient.

39. (canceled)

40. (canceled)

41. (canceled)

42. A computer program product comprising a non-transitory computer-readable storage medium having computer-readable instructions stored thereon, the computer-readable instructions being executable by a computerized device comprising processing hardware to execute the method of any one of claims 22 to 37.
